(19) United States
(12) Patent Application Publication
(10) Pub. No.: US 2015/0214760 A1
(43) Pub. Date: Jul. 30, 2015

(54) PORTABLE SPEAKER WITH REMOVABLE RECHARGEABLE BATTERY PACK

(71) Applicant: SDI Technologies, Inc., Rahway, NJ (US)

(72) Inventor: Chabetaye Sean Chraime, Rahway, NJ (US)

(21) Appl. No.: 14/610,443

(22) Filed: Jan. 30, 2015

Related U.S. Application Data
(60) Provisional application No. 61/933,760, filed on Jan. 30, 2014.

(51) Int. Cl. H02J 7/00

(52) U.S. Cl. CPC H02J 7/0044; H02J 7/0054

(57) ABSTRACT

The present disclosure provides rechargeable battery systems and methods. A rechargeable battery is provided that is configured to be removably coupled to a first electronic device. The electronic device includes a plurality of electrical device contacts. The rechargeable battery includes a plurality of electrical battery contacts configured for input and output of electrical energy between the rechargeable battery and the first electronic device upon electrically coupling the plurality of electrical battery contacts to the plurality of electrical device contacts. The rechargeable battery includes an output port configured for output of electrical energy from the rechargeable battery to a second electronic device. The rechargeable battery permits connection of the output port to the second electronic device to output electrical energy from the rechargeable battery to the second electronic device as the battery is being charged by the first electronic device.

### CROSS REFERENCE TO RELATED APPLICATIONS

The present application claims priority to U.S. Provisional Application No. 61/933,760, filed Jan. 30, 2014, entitled “PORTABLE SPEAKER WITH REMOVABLE RECHARGEABLE BATTERY PACK,” which application is incorporated herein by reference in its entirety.

### FIELD OF THE INVENTION

This invention relates generally to consumer audio electronics, particularly those designed for mobile use. It is comprised of a portable speaker system, or other small electronic device, with a removable, rechargeable battery pack.

### BACKGROUND

There are several portable speakers (Bluetooth and non-Bluetooth) available on the market that are powered by internal rechargeable batteries (li-ion, li-polymer, etc). Some such portable speakers are designed to allow the user to charge their mobile devices (e.g., their phone) using the power supply of the internal rechargeable battery (usually via a USB port on the speaker). However, none of the speakers are designed to allow the user to remove the rechargeable battery.

### SUMMARY

The invention is centered around the deliberate design of allowing the user to remove the rechargeable battery from the speaker and continue using the rechargeable battery for the purpose of charging mobile devices.

In view of the foregoing, the present disclosure is directed to apparatuses, systems and methods that provide rechargeable battery systems.

Various embodiments provide an apparatus comprising a rechargeable battery configured to be removably coupled to a first electronic device. The electronic device includes a plurality of electrical device contacts. The rechargeable battery includes a plurality of electrical battery contacts, the electrical battery contacts are configured for input and output of electrical energy between the rechargeable battery and the first electronic device upon electrically coupling the plurality of electrical battery contacts to the plurality of electrical device contacts. The rechargeable battery includes an output port configured for output of electrical energy from the rechargeable battery to a second electronic device. The rechargeable battery is configured for coupling to the second electronic device in a configuration that positions the plurality of electrical battery contacts between the rechargeable battery and the first electronic device and exposes the output port of the rechargeable battery via an opening of the second electronic device. The configuration permits connection of the output port to the second electronic device to output electrical energy from the rechargeable battery to the second electronic device as the battery is being charged by the first electronic device.

In particular embodiments, the first electronic device includes an opening in a peripheral wall of the first electronic device and the configuration causes alignment of the output port and the opening, the opening providing access to the output port. The first electronic device includes a plurality of speakers, in accordance with particular embodiments. The first electronic device may include a trough positioned between the plurality of speakers and the plurality of electrical device contacts may be positioned in the trough. In particular embodiments, at least one of the first electronic device and the rechargeable battery includes a magnet configured to magnetically couple the other one of the first electronic device and the rechargeable battery in the configuration. The first electronic device may include a shaft including a first magnet having a first polarity and a second magnet having a second polarity. The shaft is movable from a first position to magnetically attract the rechargeable battery via the first magnet for holding the battery in place and a second position to magnetically repel the rechargeable battery via the second magnet for removal of the battery from the first electronic device. The apparatus includes a controller configured to cause the shaft to move from the first position to the second position, in accordance with particular embodiments. An actuator may be electrically coupled to the controller and the shaft to actuate movement of the shaft from the first position to the second position. In particular embodiments, the apparatus includes a biased spring movable from a first state to a second state. The biased spring is less compressed in the second state than in the first state. The biased spring is configured to be moved from the first state to the second state by a movable actuator. The biased spring is configured to move the rechargeable battery from the configuration positioning the plurality of electrical battery contacts between the rechargeable battery and the first electronic device and electrically coupling the plurality of electrical battery contacts to a second configuration wherein the plurality of electrical battery contacts are separated from the plurality of electrical device contacts. At least one of the first electronic device and the rechargeable battery may include an AC power adapter port.

In particular embodiments, the rechargeable battery is composed of a plurality of colors and the rechargeable battery is configured for coupling to the first electronic device to display a first color in a first orientation. The rechargeable battery is also configured for coupling to the first electronic device to display a second color in a second orientation.

Various embodiments provide a method of operating a rechargeable battery device. The method of operating a rechargeable battery device includes coupling a rechargeable battery to a first electronic device. The first electronic device includes a plurality of electrical device contacts. The rechargeable battery includes a plurality of electrical battery contacts. The electrical battery contacts are configured for input and output of electrical energy between the rechargeable battery and the first electronic device upon electrically coupling the plurality of electrical battery contacts to the plurality of electrical device contacts. The rechargeable battery includes an output port configured for output of electrical energy from the rechargeable battery to a second electronic device. Coupling the rechargeable battery to the first electronic device includes positioning the plurality of electrical battery contacts between the rechargeable battery and the first electronic device and exposing the output port via an opening of the first electronic device. The coupling permits the output port to be connected to the second electronic device to output electrical energy from the rechargeable battery to the second electronic device as the battery is being charged by the first electronic device. The method also includes recharging the rechargeable battery via a power source coupled to the first electronic device. The rechargeable battery is recharged via the plurality of electrical battery contacts.

In particular embodiments, the method includes coupling the second electronic device to the output port. The method may include causing power to flow from the output port to the second electronic device. The method includes removing the rechargeable battery from the first electronic device, in accordance with particular embodiments. The method may include coupling the second electronic device to the output port and causing power to flow from the output port to the second electronic device.

In particular embodiments, removing the rechargeable battery comprises actuating a shaft including a first magnet having a first polarity and a second magnet having a second polarity where the shaft is actuated to move from a first position a first position to magnetically attract the rechargeable battery via the first magnet for holding the battery in place and from the first position to a second position to magnetically repel the rechargeable battery via the second magnet for removal of the battery from the first electronic device.

Removing the rechargeable battery includes changing a biased spring from a first state to a second state via a movable actuator, in accordance with particular embodiments. The biased spring is less compressed in the second state than in the first state, whereby the biased spring causes the rechargeable battery to move from the configuration positioning the plurality of electrical battery contacts between the rechargeable battery and the first electronic device. Changing the biased spring from the first state to the second state electrically couples the plurality of electrical battery contacts to a second configuration wherein the plurality of electrical battery contacts are separated from the plurality of electrical device contacts.

In particular embodiments, the method also includes causing power to flow from the rechargeable battery to the first electronic device.

Another embodiment provides an apparatus including a first electronic device that includes a plurality of electrical device contacts, a plurality of speakers, a trough positioned between the plurality of speakers, and a peripheral wall portion including an opening. The trough houses the plurality of electrical device contacts. The apparatus also includes a rechargeable battery removably coupled to the first electronic device. The rechargeable battery includes a plurality of electrical battery contacts configured for input and output of electrical energy between the rechargeable battery and the first electronic device upon electrically coupling the plurality of electrical battery contacts to the plurality of electrical device contacts. The rechargeable battery includes an output port configured for output of electrical energy from the rechargeable battery to a second electronic device. The rechargeable battery is removably coupled to the first electronic device in a configuration that positions the plurality of electrical battery contacts between the rechargeable battery and the first electronic device, whereby the first electronic device and the rechargeable battery are electrically coupled The rechargeable battery is removably coupled to the first electronic device in a configuration that aligns the output port and the opening in the peripheral wall to expose the output port, whereby the output port is connectable to the second electronic device to output electrical energy from the rechargeable battery to the second electronic device as the battery is being charged by the first electronic device.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 shows one embodiment of the invention in the assembled state. That is to say, the removable battery is housed inside a portable speaker.

FIGS. 2A-2C illustrate a mechanism for removably and replacably housing the battery in the speaker.

FIGS. 3A-3C illustrate a second mechanism for removably and replacably housing the battery in the speaker.

FIGS. 4A-4B illustrate a third mechanism for removably and replacably housing the battery in the speaker.

The features and advantages of the present invention will become more apparent from the detailed description set forth below when taken in conjunction with the drawings.

### DETAILED DESCRIPTION

Following below are more detailed descriptions of various concepts related to, and embodiments of, inventive apparatuses, systems, and methods of a manufacturing and implementing rechargeable battery systems.

In one embodiment, a rechargeable battery designed for use in a portable speaker has an enclosure that allows it to function as a standalone power supply to external devices even when it is removed from the portable speaker.

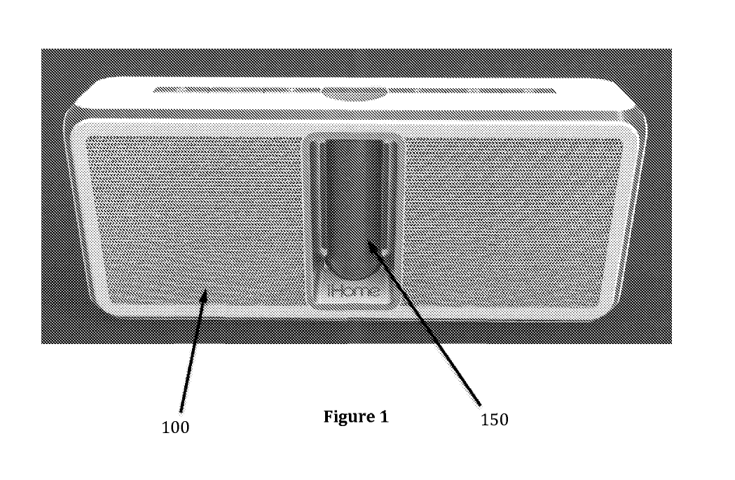

Referring to the embodiment of FIG. 1, when the speaker (100) and rechargeable battery (150) are connected, the rechargeable battery (150) powers the speaker via conductive contacts (not shown in FIG. 1) present on the battery enclosure and the portable speaker enclosure. The speaker is also designed to replenish power to the battery via current that is supplied by an external AC adapter via the main control board of the speaker and through the same conductive contacts mentioned earlier.

It should be understood that the speaker may be portable or non-portable, and may take on other shapes and configurations, and also that the invention may be implemented in devices other than speakers, such as video players, video games, and the like. In one embodiment, the battery may be configured to fit into and power multiple different devices. In other embodiments, multiple removable batteries may be used to power one device, either in separate openings or in a single opening, such as if the batteries were stacked on top of each other or nested inside one another.

Like the speaker, the battery may take various shapes in addition to the cylinder shown in the figures, such as square or rectangular forms, full or partial spheres, full or partial cones, etc.

In some embodiments, the opening in the speaker is configured such that some or all of the battery is visible even when fully inserted into the device. In this way, the battery can contribute to the aesthetics of the device and, in some embodiments, can contribute a certain design aesthetic across a line of speakers or other devices.

Batteries in some cases may be offered in different colors or patterns, coordinating or contrasting with the colors or patterns of the speaker itself, allowing a consumer to customize the look of their device. Some embodiments of the invention may provide white or colored illumination of the battery that can be seen after its insertion into the device, further enhancing the aesthetics. In still other embodiments, the surface of the battery may be adorned with LEDs or other lighting that is static and/or provides one or more visual effects.

In some embodiments, when the battery (150) is removed from the device, it can function as a stand-alone power source capable of charging devices (e.g., phones, tablets, handheld game systems, etc.) via connecting ports designed for external charging/output operations. In other words, the battery (150) may be specifically configured to fit into a certain device, while at the same time being configured to power other devices using a separate, standard connector.

In another embodiment, the battery (150) may have just one connector, e.g., a female USB connector, that allows it to power both a specific device when inserted into that device, and also a different device when removed, using the same connector.

When the battery (150) is removed from the speaker (100) the battery's power can still be replenished via a physical cable and almost any 5V power source (PC/MAC USB ports, etc.) connected to ports (USB, etc.) on the battery designed for the external charging/input operations.

In some embodiments, the speaker (100) can function as a powered speaker with the battery removed, because it contains a DC input for supplemental power source that is provided by an AC adapter.

In another embodiment, the invention allows the speaker (200) to function as a portable powered speaker even when the battery is removed because the speaker (200) also contains a non-removable rechargeable battery.

In another embodiment, the invention is configured such that the battery's external charging port is accessible when the battery is inserted in the speaker, such that the port can be used to charge an external device when it is installed in the speaker, including when it is either charging the speaker or being charged by the speaker.

One aspect of certain embodiments is mechanical design that allows for the user to remove and replace the battery with ease. The battery may include a magnet within its enclosure that allows it to affix to the speaker embodiment.

It is desirable that the battery remain securely in place inside the speaker when it's intended to be there, while also being relatively easy to remove when the user so desires.

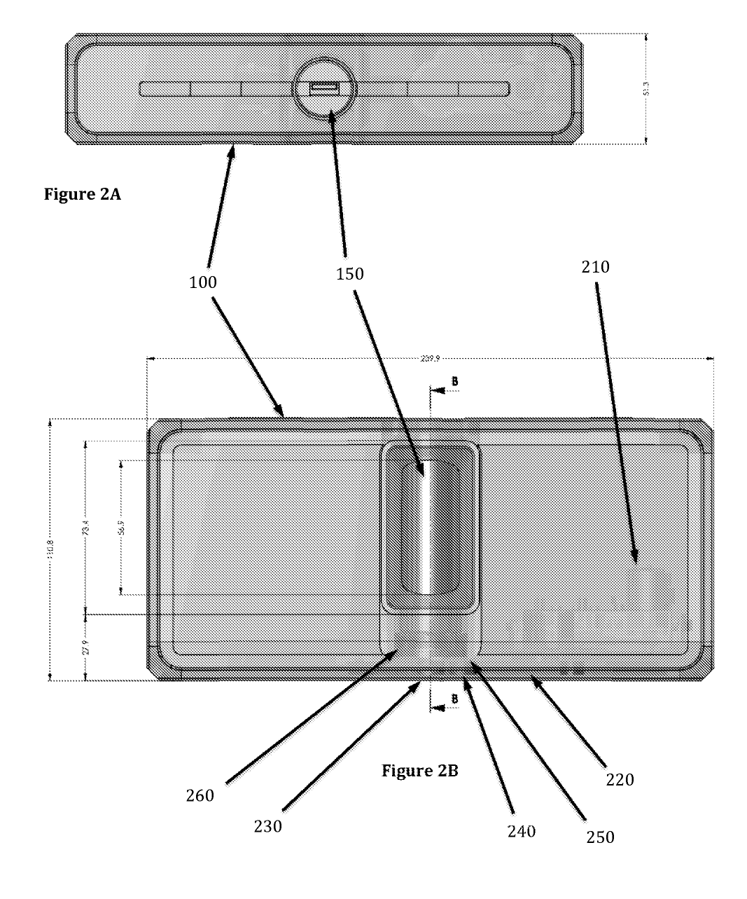

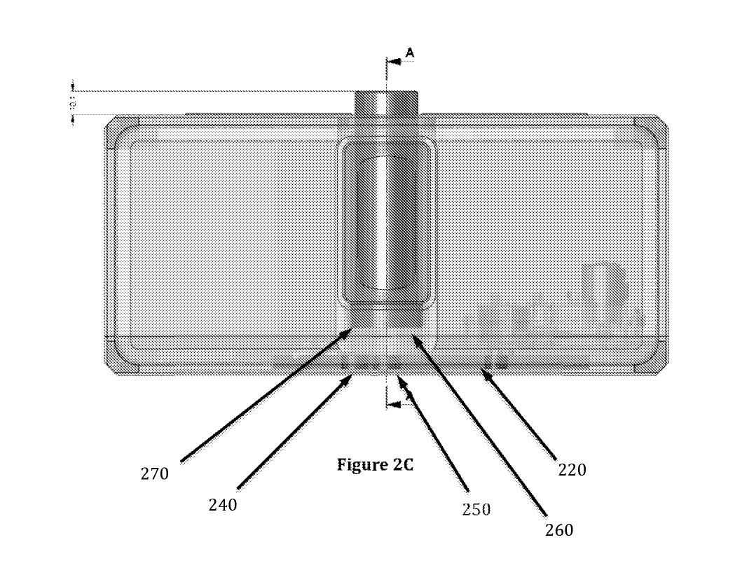

In a first embodiment, shown in FIGS. 2A-2C, the battery (150) has three electrical connection points, one for “+”, one for “−”, and one for ground, and the speaker (100) has three cooperating contacts located on a platform at the bottom of an opening configured to receive the battery. A magnetic force created by a shaft magnet (260) keeps the battery in place, and the contacts engaged, in the event that the speaker is moved.

The speaker includes an “eject” button (not shown) that communicates by software to the main controller IC (not shown). The controller controls the motor (210), which in turn controls the shaft (220).

The motor pushes the shaft (220) between a first position and a second position. At the first position (shown in FIG. 2B), a first magnet (230) (of opposing polarity to a second magnet (240)) is in place to hold the elevator platform (250) down inside the speaker. When the eject button is pressed and the shaft is moved to the second position (as in FIG. 2C), the second magnet of equal polarity to the shaft magnet is in place to push the elevator platform (250) and battery (150) up, such that the battery extends out of the speaker (as in FIG. 2C) so the user can pull it out.

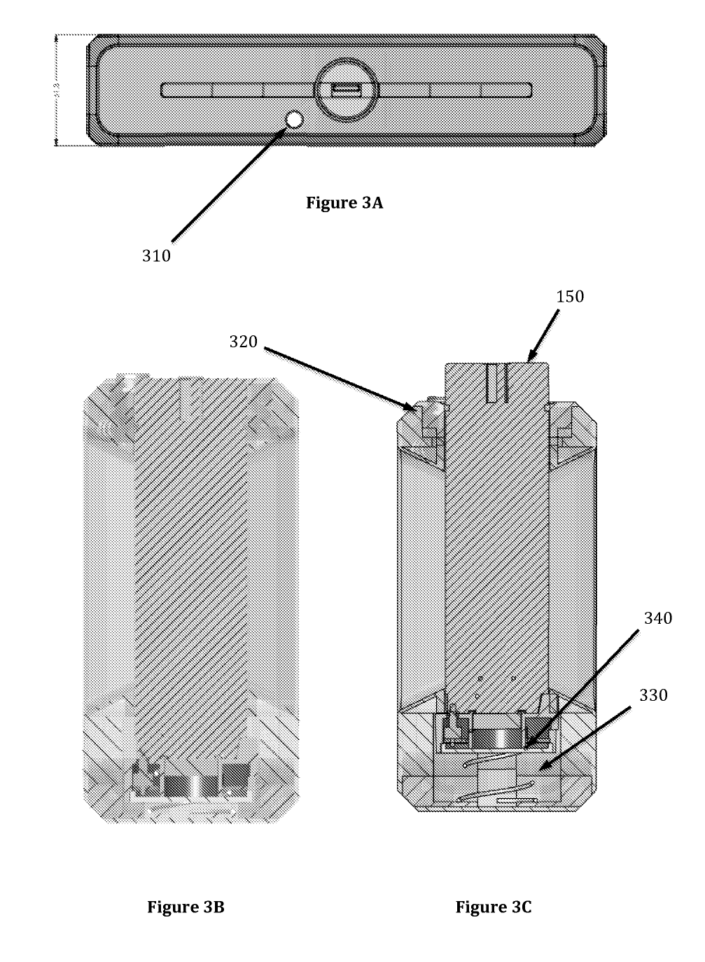

In a second embodiment, shown in FIGS. 3A-3C, the battery and the speaker have the same electrical connections as in the first embodiment, but the magnetic method for retaining and ejecting the battery is replaced by a mechanical one.

In particular, the speaker housing includes an eject button (310) that is coupled to a spring loaded latch (320). The latch extends into the opening in the speaker that receives the battery and is biased in that position by its spring. The latch and battery are shaped such that the latch is pushed out of the opening when the battery is inserted, but moves back into the opening and engages a notch or other structure on the battery when the battery is fully inserted, thereby locking it into place. When the eject button (310) is depressed, the latch (320) is retracted out of the opening, and a spring (330) positioned at the bottom of the opening pushes an elevator platform (340) up, pushing the battery upwards so that it can be grasped and removed by the user.

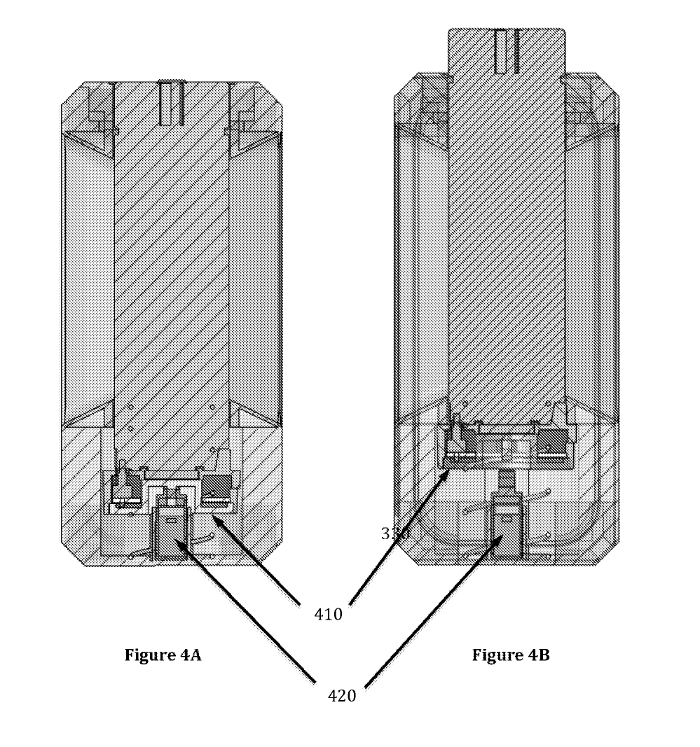

In a third embodiment, shown in FIGS. 4A-4B, the battery (150) and the speaker (100) have the same electrical connections as in the first two embodiments. When a user inserts the battery (150) into the opening in the speaker (100), a magnetic force between the bottom of the battery (150) and the elevator platform (410) retains the battery in place. This can be accomplished, for example, with a magnet in the platform and a metal plate in the battery, or the opposite arrangement. The elevator platform is supported by a push lock mechanism (420). When the user inserts the battery into the opening, the push lock mechanism (420) is compressed and locked at the compressed position. When the battery (150) is depressed further, the mechanism releases and pushes the battery up, so that it can be grasped by the user.

The battery (150) may include surface features that cooperate with structures in or on the housing, such as in the opening of the housing, to ensure that the electrical contacts mate properly when the battery is inserted. In other embodiments, the contacts may be configured (such as concentrically) so that the appropriate electrical connections are made no matter how the battery is oriented. In some embodiments, the battery may be insertable in different orientations and may have different colors, designs, patterns, or other features that are visible depending on which orientation is used. For example, one side of the battery could be while and other black, providing a different appearance depending on how the battery is inserted.

In still another embodiment, the battery, or the platform that holds the battery, may be rotatable after the battery is inserted, either by hand or by a motor or other mechanism in the speaker. The latter embodiment might allow, for example, for a barber pole or disco ball effect, particularly if coupled with the lighting described above.

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure. It is recognized that features of the disclosed embodiments can be incorporated into other disclosed embodiments.

It is important to note that the constructions and arrangements of apparatuses or the components thereof as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, describes techniques, or the like, this application controls.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. An apparatus comprising:
a rechargeable battery configured to be removably coupled to a first electronic device, the electronic device including a plurality of electrical device contacts, the rechargeable battery including a plurality of electrical battery contacts, the electrical battery contacts configured for input and output of electrical energy between the rechargeable battery and the first electronic device upon electrically coupling the plurality of electrical battery contacts to the plurality of electrical device contacts,
wherein the rechargeable battery includes an output port configured for output of electrical energy from the rechargeable battery to a second electronic device,
wherein the rechargeable battery is configured for coupling to the second electronic device in a configuration that positions the plurality of electrical battery contacts between the rechargeable battery and the first electronic device and exposes the output port of the rechargeable battery via an opening of the second electronic device,
whereby the output port is connectable to the second electronic device to output electrical energy from the rechargeable battery to the second electronic device as the battery is being charged by the first electronic device.

2. The apparatus according to claim 1, wherein the first electronic device includes an opening in a peripheral wall of the first electronic device and the configuration causes alignment of the output port and the opening, the opening providing access to the output port.

3. The apparatus according to claim 1, wherein the first electronic device includes a plurality of speakers.

4. The apparatus according to claim 2, wherein the first electronic device includes a trough positioned between the plurality of speakers, the plurality of electrical device contacts positioned in the trough.

5. The apparatus according to claim 1, wherein at least one of the first electronic device and the rechargeable battery includes a magnet configured to magnetically couple the other one of the first electronic device and the rechargeable battery in the configuration positioning the plurality of electrical battery contacts between the rechargeable battery and the first electronic device and electrically coupling the plurality of electrical battery contacts and the plurality of electrical device contacts.

6. The apparatus according to claim 1, wherein the first electronic device includes a shaft including a first magnet having a first polarity and a second magnet having a second polarity the shaft movable from a first position to magnetically attract the rechargeable battery via the first magnet for holding the battery in place and a second position to magnetically repel the rechargeable battery via the second magnet for removal of the battery from the first electronic device.

7. The apparatus according to claim 6, further comprising a controller configured to cause the shaft to move from the first position to the second position.

8. The apparatus according to claim 7, further comprising an actuator electrically coupled to the controller and the shaft to actuate movement of the shaft from the first position to the second position.

9. The apparatus according to claim 1, further comprising a biased spring movable from a first state to a second state, the biased spring less compressed in the second state than in the first state, the biased spring configured to be moved from the first state to the second state by a movable actuator, the biased spring configured to move the rechargeable battery from the configuration positioning the plurality of electrical battery contacts between the rechargeable battery and the first electronic device and electrically coupling the plurality of electrical battery contacts to a second configuration wherein the plurality of electrical battery contacts are separated from the plurality of electrical device contacts.

10. The apparatus according to claim 1, wherein at least one of the first electronic device and the rechargeable battery includes an AC power adapter port.

11. The apparatus according to claim 1, wherein the rechargeable battery is composed of a plurality of colors, the rechargeable battery configured for coupling to the first electronic device to display a first color in a first orientation, the rechargeable battery configured for coupling to the first electronic device to display a second color in a second orientation.

12. A method of operating a rechargeable battery device comprising:
coupling a rechargeable battery to a first electronic device, the first electronic device including a plurality of electrical device contacts, the rechargeable battery including a plurality of electrical battery contacts, the electrical battery contacts configured for input and output of electrical energy between the rechargeable battery and the first electronic device upon electrically coupling the plurality of electrical battery contacts to the plurality of electrical device contacts,
wherein the rechargeable battery includes an output port configured for output of electrical energy from the rechargeable battery to a second electronic device,
wherein coupling the rechargeable battery to the first electronic device includes:
positioning the plurality of electrical battery contacts between the rechargeable battery and the first electronic device and exposing the output port via an opening of the first electronic device whereby the output port is connectable to the second electronic device to output electrical energy from the rechargeable battery to the second electronic device as the battery is being charged by the first electronic device; and
recharging the rechargeable battery via a power source coupled to the first electronic device, the rechargeable battery recharged via the plurality of electrical battery contacts.

13. The method according to claim 12, further comprising coupling the second electronic device to the output port.

14. The method according to claim 13, further comprising causing power to flow from the output port to the second electronic device.

15. The method according to claim 12, further comprising removing the rechargeable battery from the first electronic device.

16. The method according to claim 15, further comprising:
coupling the second electronic device to the output port; and
causing power to flow from the output port to the second electronic device.

17. The method according to claim 15, wherein removing the rechargeable battery comprises actuating a shaft including a first magnet having a first polarity and a second magnet having a second polarity, the shaft actuated to move from a first position a first position to magnetically attract the rechargeable battery via the first magnet for holding the battery in place and a second position to magnetically repel the rechargeable battery via the second magnet for removal of the battery from the first electronic device.

18. The method according to claim 15, wherein removing the rechargeable battery comprises changing a biased spring from a first state to a second state via a movable actuator, the biased spring less compressed in the second state than in the first state, whereby the biased spring causes the rechargeable battery to move from the configuration positioning the plurality of electrical battery contacts between the rechargeable battery and the first electronic device and electrically coupling the plurality of electrical battery contacts to a second configuration wherein the plurality of electrical battery contacts are separated from the plurality of electrical device contacts.

19. The method according to claim 12, further comprising causing power to flow from the rechargeable battery to the first electronic device.

20. An apparatus comprising:
a first electronic device including:
a plurality of electrical device contacts,
a plurality of speakers,
a trough positioned between the plurality of speakers, the trough housing the plurality of electrical device contacts, and
a peripheral wall portion including an opening; and
a rechargeable battery removably coupled to the first electronic device, the rechargeable battery including a plurality of electrical battery contacts configured for input and output of electrical energy between the rechargeable battery and the first electronic device upon electrically coupling the plurality of electrical battery contacts to the plurality of electrical device contacts, the rechargeable battery including an output port configured for output of electrical energy from the rechargeable battery to an second electronic device,
wherein the rechargeable battery is removably coupled to the first electronic device in a configuration:
1) positioning the plurality of electrical battery contacts between the rechargeable battery and the first electronic device, whereby the first electronic device and the rechargeable battery are electrically coupled, and
2) aligning the output port and the opening in the peripheral wall to expose the output port, whereby the output port is connectable to the second electronic device to output electrical energy from the rechargeable battery to the second electronic device as the battery is being charged by the first electronic device.
